(19) United States
(12) Patent Application Publication
(10) Pub. No.: US 2010/0183227 A1
(43) Pub. Date: Jul. 22, 2010

(54) Person detecting apparatus and method and privacy protection system employing the same

(75) Inventors: Chanmin Park, Seongnam-si (KR); Sangmin Yoon, Yongin-si (KR); Sangryong Kim, Yongin-si (KR); Dongkwan Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/656,064

(22) Filed: Jan. 14, 2010

Related U.S. Application Data
(63) Continuation of application No. 10/991,077, filed on Nov. 18, 2004.

(30) Foreign Application Priority Data
Nov. 18, 2003 (KR) 10-2003-0081885

(51) Int. Cl. G06K 9/46

(52) U.S. Cl. 382/195

(57) ABSTRACT

A person detection apparatus and method, and a privacy protection system using the method and apparatus, the person detection apparatus includes: a motion region detection unit, which detects a motion region from a current frame image using motion information between frames; and a person detecting/tracking unit, which detects a person in the detected motion region using shape information of persons, and performs a tracking process on a motion region detected as the person in a previous frame image within a predetermined tracking region.

### CROSS-REFERENCE TO RELATED APPLICATION

This application is a continuation of application Ser. No. 10/991,077 filed Nov. 18, 2004, the disclosure of which is incorporated herein in its entirety by reference. This application claims the priority of Korean Patent Application No. 2003-81885, filed on Nov. 18, 2003 in the Korean Intellectual Property Office, the disclosure of which is incorporated herein by reference.

### BACKGROUND OF THE INVENTION

1. Field of the Invention

The present relates to object detection, and more particularly, a person detecting apparatus and method of accurately and speedily detecting the presence of a person from an input image and a privacy protection system protecting personal privacy by displaying a mosaicked image of a detected person's face.

2. Description of the Related Art

As modern society becomes more complex and crime becomes more sophisticated, society's interest in protection is increasing and more and more public facilities are being equipped with a large number of security cameras. Since it is difficult to manually control a large number of security cameras, an automatic control system has been developed.

Several face detection apparatuses for detecting a person have been developed. In most of the face detection apparatuses, the motion of an object is detected by using a difference image between a background image stored in advance and an input image. Alternatively, a person is detected by using only shape information about the person, indoors or outdoors. The method using the difference of an image between the input image and the background image is effective when the camera is fixed. However, if the camera is attached to a moving robot, the background image continuously changes. Therefore, the method using the difference of the image is not effective. On the other hand, in the method using the shape information, a large number of model images must be prepared, and an input image must be compared with all the model images in order to detect the person. Thus, the method using the shape information is overly time-consuming.

Today, since too many security cameras are installed, there is a problem in that personal privacy may be invaded. Therefore, there has been a demand for a system for storing detected persons and rapidly searching a person while protecting personal privacy.

### SUMMARY OF THE INVENTION

According to an aspect of the present invention, there is provided a person detecting apparatus and method of accurately and speedily detecting the presence of a person from an input image by using motion information and shape information of an input image.

According to another aspect of the present invention, there is also provided a privacy protection system protecting a right to a personal portrait by displaying a mosaicked image of a detected person's face.

According to an aspect of the present invention, there is provided a person detection apparatus including: a motion region detection unit, which detects a motion region from a current frame image by using motion information between frames; and a person detecting/tracking unit, which detects a person in the detected motion region by using shape information of persons, and performs a tracking process on a motion region detected as a person in a previous frame image within a predetermined tracking region.

According to another aspect of the present invention, there is provided a person detection method including: detecting a motion region from a current frame image by using motion information between frames; and detecting a person in the detected motion region by using shape information of persons, and performing a tracking process on a motion region detected as a person in a previous frame image within a predetermined tracking region.

According to still another aspect of the present invention, there is provided a privacy protection system including: a motion region detection unit, which detects a motion region from a current frame image by using motion information between frames; a person detecting/tracking unit, which detects a person in the detected motion region by using shape information of persons, and performs a tracking process on a motion region detected as a person in a previous frame image within a predetermined tracking region; a mosaicking unit, which detects the face in the motion region, which is determined to correspond to the person, performs a mosaicking process on the detected face, and displays the mosaicked face; and a storage unit, which stores the motion region, which is detected or tracked as a person, and stores predetermined labels and position information used for searching frame units.

Additional aspects and/or advantages of the invention will be set forth in part in the description which follows and, in part, will be obvious from the description, or may be learned by practice of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects and advantages of the invention will become apparent and more readily appreciated from the following description of the embodiments, taken in conjunction with the accompanying drawings of which:

FIG. 1 is a block diagram showing a person detection apparatus according to an embodiment of the present invention;

FIG. 2 is a detailed block diagram of a motion detection unit of FIG. 1; FIGS. 3A to 3C show examples of images input to each component of FIG. 2;

FIG. 4 is a detailed block diagram of a person detecting/tracking unit of FIG. 1;

FIG. 5 is a view explaining an operation of a normalization unit of FIG. 4;

FIG. 6 is a detailed block diagram of a candidate region detection unit of FIG. 4;

FIG. 7 is a detailed block diagram of a person determination unit of FIG. 4;

FIGS. 8A to 8C show examples of images input to each component of FIG. 7; and

FIG. 9 is a diagram explaining a person detection method in a person detecting/tracking unit of FIG. 1.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

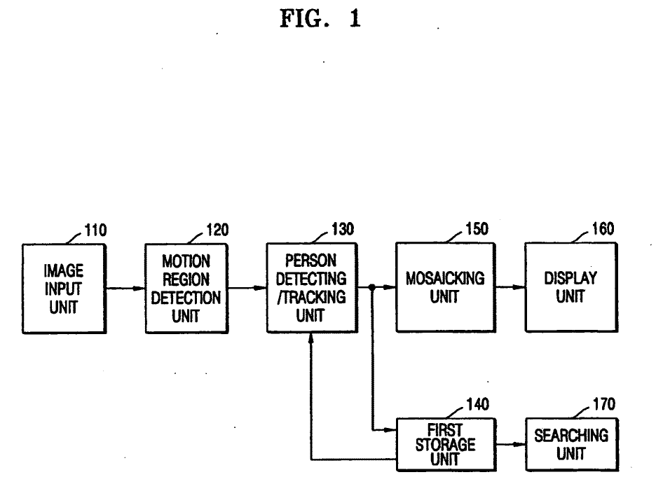

FIG. 1 is a block diagram showing a person detection apparatus according to an embodiment of the present invention. The person detection apparatus includes an image input unit 110, a motion region detection unit 120, and a person detecting/tracking unit 130. In addition, the person detection apparatus further includes a first storage unit 140, a mosaicking unit 150, a display unit 160, and a searching unit 170.

In the image input unit 110, an image picked up by a camera is input in units of a frame.

The motion region detection unit 120 detects a background image by using motion information between a current frame image and a previous frame image transmitted from the image input unit 110, and detects at least one motion region from a difference image between the current frame image and the background image. Here, the background image is a motionless image, that is, an image where there is not a motion.

The person detecting/tracking unit 130 detects a person candidate region from the motion regions provided from the motion region detection unit 120 and determines whether the person candidate region corresponds to a person. On the other hand, a motion region in the current frame image which is determined to correspond to the person is not subjected to a general detection process for the next frame image. A tracking region is allocated to the motion region, and a tracking process is performed on the tracking region.

The first storage unit 140 stores the motion regions, each of which is determined to correspond to a person in the person detecting/tracking unit 130, their labels, and their position information. The motion regions are stored in units of a frame. The first storage unit 140 provides the motion region, their labels, and their position information to the person detecting/tracking unit 130 in response to the input of the next frame image.

The mosaicking unit 150 detects a face from the motion region which is determined to correspond to the person in the person detecting/tracking unit 130, performs a well-known mosaicking process on the detected face, and provides the mosaicked face to the display unit 160. In general, there are various methods of detecting a face from a motion region. For example, a face detection method using a Gabor filter or a support vector machine (SVM) may be used. The face detection method using the Gabor filter is disclosed in an article, entitled “Face Recognition Using Principal Component Analysis of Gabor Filter Responses” by Ki-chung Chung, Seok-Cheol Kee, and Sang-Ryong Kim, International Workshop on Recognition, Analysis and Tracking of Faces and Gestures in Real-Time Systems, Sep. 26-27, 1999, Corfu, Greece. The face detection method using the SVM is disclosed in an article, entitled “Training Support Vector Machines: an application to face detection” by E. Osuna, R. Freund, and F. Girosi, In Proc. of CVPR, Puerto Rico, pp. 130-136, 1997.

In response to a user's request, the searching unit 170 searches the motion regions determined to correspond to a person stored in the first storage unit 140

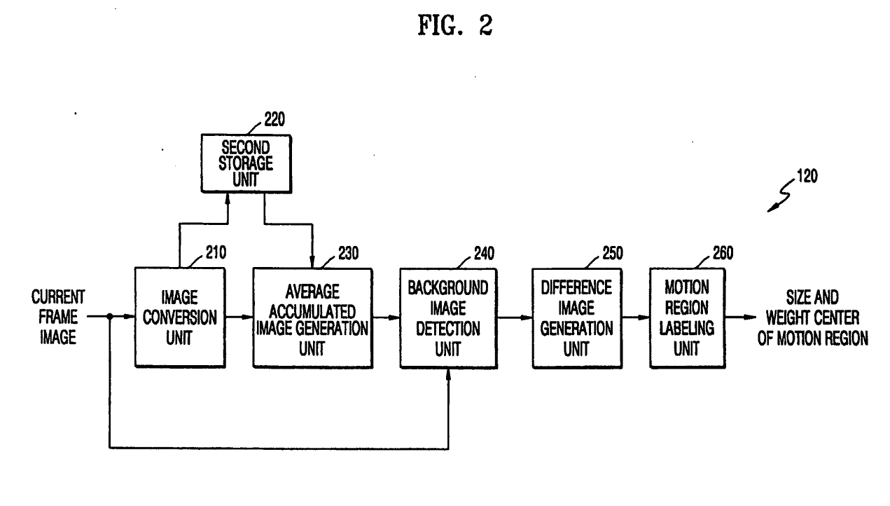

FIG. 2 is a block diagram showing components of the motion region detection unit 120 of FIG. 1. The motion region detection unit 120 comprises an image conversion unit 210, a second storage unit 220, an average accumulated image generation unit 230, a background image detection unit 240, a difference image generation unit 250, and a motion region labeling unit 260. Operations of the components of the motion region detection unit 120 of FIG. 2 will be described with reference to FIGS. 3A to 3C.

Referring to FIG. 2, the image conversion unit 210 converts the current frame image into a black-and-white image. If the current frame image is a color image, the color image is converted into the black-and-white image. If the current frame image is a black-and-white image, the black-and-white image needs not to be converted. The black-and-white image is provided to the second storage unit 220 and to the average accumulated image generation unit 230. By using the black-and-white image in the person detection process, it is possible to reduce influence of illumination and processing time. The second storage unit 220 stores the current frame image provided from the image conversion unit 210. The current frame image stored in the second storage unit 220 is used to generate the average accumulated image of the next frame.

The average accumulated image generation unit 230 obtains an average image between the black-and-white image of the current frame image and the previous frame image stored in the second storage unit 220, adds the average image to the average accumulated image from the previous frame to generate the average accumulated image for the current frame. In the average accumulated image for a predetermined number of frames, a region where the same pixel values are added is determined to be a motionless region, and a region where different pixel values are added is determined to be a motion region. More specifically, the motion region is determined by using a difference between a newly added pixel value and the previous average accumulated pixel value.

In the background image detection unit 240, a region where the same pixel values are continuously added to the average accumulated image for the predetermined frames, that is, a region where the pixel values do not change, is detected as a background image in the current frame. The background image is updated every frame. If the number of frames for use in detecting the background image increases, the accuracy of the background image increases. An example of the background image in the current frame is shown in FIG. 3B.

The difference image generation unit 250 obtains a difference between pixel values of the background image in the current frame and the current frame image in units of a pixel. A difference image is constructed with pixels where the difference between the pixel values is more than a predetermined threshold value. The difference image represents all moving objects. On the other hand, if the predetermined threshold value is small, a small-motion region may be not discarded but used to detect a person candidate region.

As shown in FIG. 3C, in the motion region labeling unit 260, a labeling process is performed on the difference image transmitted from the difference image generation unit 250 to allocate labels to the motion regions. As a result of the labeling process, the size and the coordinate of weight center of each of the motion regions are output. Each of the sizes of the labeled motion region is represented by start and end points in the x and y-axes. The coordinate of the weight center 310 is determined from sum of pixel values of the labeled motion region.

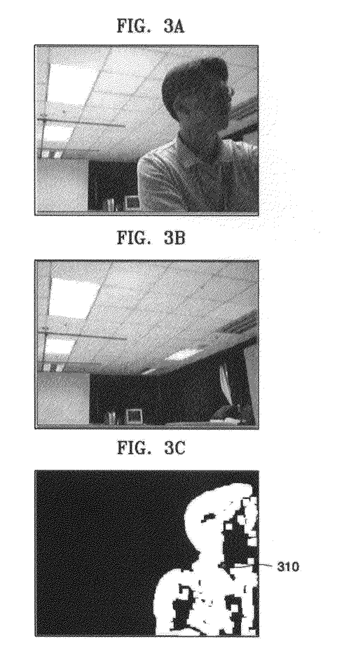

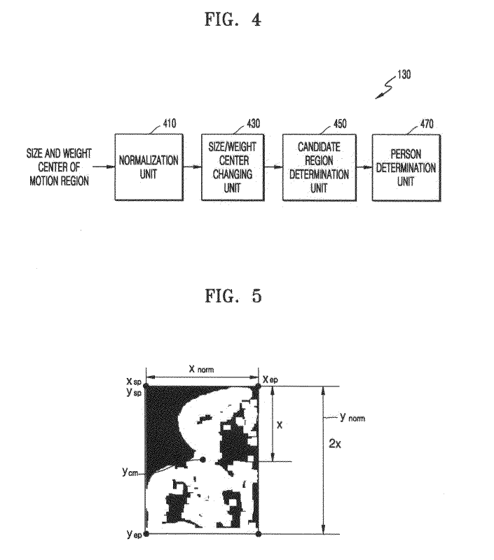

FIG. 4 is a detailed block diagram of the person detecting/tracking unit 130 of FIG. 1. The person detecting/tracking unit 130 includes a normalization unit 410, a size/weight center changing unit 430, a candidate region detection unit 450, and a person determination unit 470.

In the normalization unit 410, information on the sizes and weight centers of the motion regions is input, and each of the sizes of the motion regions are normalized into a predetermined size. The normalized vertical length of the motion region is longer than the normalized horizontal length of the motion region. Referring to FIG. 5, in an arbitrary motion region, the normalized horizontal length xₙₒᵣₘ is a distance from the start point xₛₚ to the end point xₑₚ in the x axis, and the normalized vertical length yₙₒᵣₘ is several times a distance x from the weight center y_{cm} to the start point yₛₚ in the y axis. Here, the yₙₒᵣₘ is preferably, but not necessarily, two times x.

The size/weight center changing unit 430 changes the sizes and weight centers of the normalized motion regions. For example, in a case where the sizes of the motion regions are scaled into s steps and the weight centers are shifted in t directions, the s×t modified shapes of the motion regions can be obtained. Here, the sizes of the motion regions change in accordance with the normalized lengths xₙₒᵣₘ and yₙₒᵣₘ of the to-be-changed motion regions. For example, the sizes can increase or decrease by a predetermined number of pixels, for example, 5 pixels, in the up, down, left, and right directions. The weight center can be shifted in the up, down, left, right, and diagonal directions, and the changeable range of the weight center is determined based on the distance x from the weight center y_{cm} to the start point yₛₚ in the y axis. By changing the sizes and weight centers, it is possible to prevent an upper or lower half of the person body from being excluded when some portion of the person body moves.

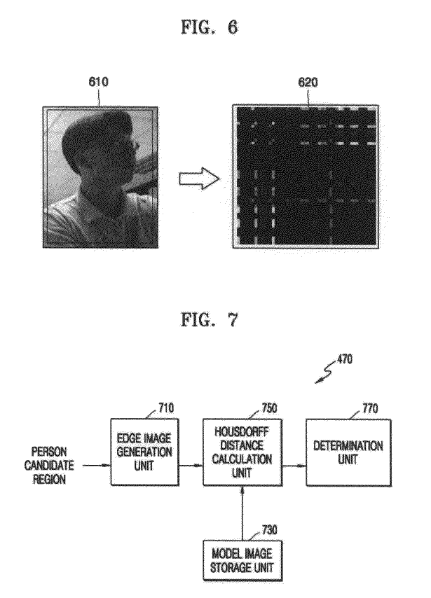

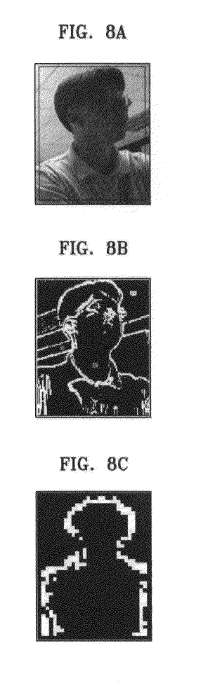

The candidate region detection unit 450 normalizes the motion regions having s×t modified shapes in units of predetermined pixels, for example, 30×40-pixels, and detects a person candidate region from the motion regions. A Mahalanobis distance map D can be used to detect the person candidate regions from the motion regions. The Mahalanobis distance map D is described with reference to FIG. 6. Firstly, the 30×40-pixel normalized image 610 is partition into blocks. For example, the image 610 may be partitioned by 6 (horizontal) and 8 (vertical), that is, into 48 blocks. Each of the blocks has 5×5 pixels. The average pixel values of each of the blocks are represented by Equation 1.

$${\overline{x}}_{l} = \frac{1}{pq} {\sum }_{( x , t ) ∈ {X}_{l}} {x}_{s , t} . \qquad [ Equation 1 ]$$

Here, p and q denote pixel numbers in the horizontal and vertical directions of a block l, respectively. Xₗ denotes total blocks, and x denotes a pixel value in a block l.

The variance of pixel values of the blocks is represented by Equation 2.

$${Σ}_{l} = \frac{1}{pq} {\sum }_{x ∈ {X}_{l}} ( x - {\overline{x}}_{l} ) {( x - {\overline{x}}_{l} )}^{T} \qquad [ Equation 2 ]$$

A Mahalanobis distance d_{(i,j)} of each of the blocks is calculated by using the average and variance of pixel values of the blocks, as shown in Equations 3. The Mahalanobis distance map D is calculated using the Mahalanobis distances d_{(i,j)}, as shown in Equation 4. Referring to FIG. 6, a normalized motion region 610 can be converted into an image 620 by using the Mahalanobis distance map D.

$$\begin{matrix}{d}_{( i , j )} = {( {\overline{x}}_{i} - {\overline{x}}_{j} )}^{′} {( {\sum }_{i} + {\sum }_{j} )}^{- 1} ( {\overline{x}}_{i} - {\overline{x}}_{j} ) & [ Equation 3 ] \\ D = [ \begin{matrix}0 & {d}_{( 1 , 2 )} & … & {d}_{( 1 , MN )} \\ {d}_{( 2 , 1 )} & 0 & … & {d}_{( 2 , MN )} \\ … & … & … & … \\ … & … & … & … \\ {d}_{( MN , 1 )} & {d}_{( MN , 2 )} & … & 0\end{matrix} ] & [ Equation 4 ]\end{matrix}$$

Here, M and N denote partition numbers of the normalized motion region 610 in the horizontal and vertical directions, respectively. When the normalized motion region 610 is portioned by 6 (horizontal) and 8 (vertical), the Mahalanobis distance map D is represented by a 48×48 matrix.

As described above, the Mahalanobis distance map is constructed for s×t modified shapes of the motion regions, respectively. Next, the dimension of the Mahalanobis distance map (matrix) may be reduced using a principal component analysis. Next, it is determined whether or not the s×t modified shapes of the motion regions belong to the person candidate region using the SVM trained in an eigenface space. If at least one of s×t modified shapes belongs to the person candidate region, the associated motion region is detected as a person candidate region.

Returning to FIG. 4, in the person determination unit 470, it is determined whether or not the person candidate region detected in the candidate region detection unit 450 corresponds to a person. The determination is performed using the Hausdorff distance. It will be described in detail with reference to FIG. 7.

FIG. 7 is a detailed block diagram of the person determination unit 470 of FIG. 4. The person determination unit 470 includes an edge image generation unit 710, a model image storage unit 730, a Hausdorff distance calculation unit 750, and a determination unit 770.

The edge image generation unit 710 detects edges from the person candidate regions out of the normalized motion regions shown in FIG. 8A to generate an edge image shown in FIG. 8B. The edge image can be speedily and efficiently generated using a Sobel edge method utilizing horizontal and vertical distributions of gradients in an image. Here, the edge image is binarized into edge and non-edge regions.

The model image storage unit 730 stores an edge image of at least one model image. Preferably, but not necessarily, the edge image of the model image includes an edge image of a long distance model image and an edge image of a short distance model image. For example, as shown in FIG. 8C, the edge image of the model image is obtained by taking an average image of upper-half of a person body in all images used for training and extracting edges of the average image.

The Hausdorff distance calculation unit 750 calculates a Hausdorff distance between an edge image A generated by the edge image generation unit 710 and an edge image B of a model image stored in the model image storage unit 730 to evaluate similarity between both images. Here, the Hausdorff distance may be represented with Euclidian distances between one specific point, that is, one edge of the edge image A, and all the specific points, that is, all the edges, of the edge image B of the model image. In a case where an edge image A has m edges and an edge image B of the model image has n edges, the Hausdorff distance H(A, B) is represented by Equation 5.

$$\begin{matrix}H ( A , B ) = max ( h ( A , B ) , h ( B , A ) ) & [ Equation 5 ] \\ Here , h ( A , B ) = {max }_{a ∈ A} {min}_{b ∈ B} ‖ a - b ‖ , \\ A = \{ {a}_{1} , … , {a}_{m} \} , and B = \{ {b}_{1} , … , {b}_{n} \} . & [ Equation 6 ]\end{matrix}$$

More specifically, the Hausdorff distance H(A, B) is obtained, as follows, Firstly, h(A, B) is obtained by selecting minimum values out of distances between each of edges of the edge image A and all the edges of the model images B and selecting a maximum value out of the minimum values for the m edges of the edge image A. Similarly, h(B, A) is obtained by selecting minimum values out of distances between each of edges of the model image B and all the edges of the edge images A and selecting a maximum value out of the minimum values for the n edges of the model image B. The Hausdorff distance H(A, B) is a maximum value out of h(A, B) and h(B, A). By analyzing the Hausdorff distance H(A, B), it is possible to evaluate the mismatching between the two images A and B. With respect to the input edge image A, the Hausdorff distances for the entire model images such as an edge image of a long distance model image and an edge image of a short distance model image stored in the model image storage unit 730 are calculated, and a maximum of the Hausdorff distances is output as a final Hausdorff distance.

The determination unit 770 compares the Hausdorff distance H(A, B) between the input edge image and the edge image of model images calculated by the Hausdorff distance calculation unit 750 with a predetermined threshold value. If the Hausdorff distance H(A, B) is equal to or more than the threshold value, the person candidate region is detected as a non-person image. Otherwise, the person candidate region is detected as a person region.

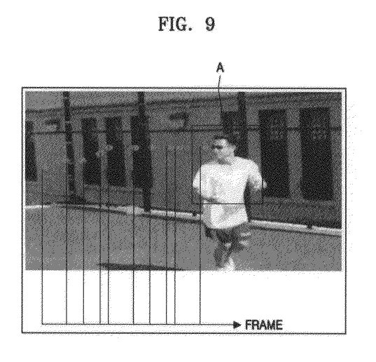

FIG. 9 is a diagram explaining a person detection method in the person detecting/tracking unit 120 of FIG. 1. A motion region detected from the previous frame which is stored together with the allocated label in the first storage unit 140 is subjected not to a detection process for the current frame, but directly to a tracking process. In other words, a predetermined tracking region A is selected so that its center is located at the motion region detected from the previous frame. The tracking process is performed on the tracking region A. The tracking process is preferably, but not necessarily, performed using a particle filtering scheme based on CONDENSATION (CONDITIONAL DENSITY PROPOGATION). The particle filtering scheme is disclosed in an article, entitled “Visual tracking by stochastic propagation of conditional density” by Isard, M and Blake, A in Proc. 4th European Conf. Computer Vision, pp. 343-356, April 1996.

The invention can also be embodied as computer-readable codes stored on a computer-readable recording medium. The computer-readable recording medium is any data storage device that can store data which can thereafter be read by a computer. Examples of the computer-readable recording medium include read-only memory (ROM), random-access memory (RAM), CD-ROMs, magnetic tapes, floppy disks, optical data storage devices, and carrier waves (such as data transmission over the Internet). The computer-readable recording medium can also be distributed over network of coupled computer systems so that the computer-readable code is stored and executed in a distributed fashion. Functional programs, codes, and code segments for accomplishing the present invention can be easily written by computer programmers of ordinary skill.

As described above, according to an aspect of the present invention, a plurality of person candidate regions are detected from an image picked up by a camera indoor or outdoor using motion information between the frames. Thereafter, by determining whether or not each of the person candidate regions corresponds to a person based on shape information of persons, it is possible to speedily and accurately detect a plurality of persons in one frame image. In addition, a person detected in the previous frame is not subjected to an additional detecting process in the current frame but directly to a tracking process. For the tracking process, a predetermined tracking region including the detected person is allocated in advance. Therefore, it is possible to save processing time associated with person detection.

In addition, frame numbers and labels of motion regions where a person is detected can be stored and searched, and a face of a detected person is subjected to a mosaicking process before displayed. Therefore, it is possible to protect the privacy of the person.

In addition, a privacy protection system according to an aspect of the present invention can be adapted to broadcast and image communication as well as an intelligent security surveillance system in order to protect the privacy of a person.

Although a few embodiments of the present invention have been shown and described, it would be appreciated by those skilled in the art that changes may be made in these embodiments without departing from the principles and spirit of the invention, the scope of which is defined in the claims and their equivalents.

1. An image processing method comprising:
receiving an image;
detecting a face in the image; and
performing a process on the detected face in the image to protect personal privacy using a person detecting apparatus.

2. The method of claim 1, wherein the image is a frame image.

3. The method of claim 1, wherein the image is one of video images.

4. The method of claim 1, wherein the process includes mosaic process.

5. An image processing method comprising:
receiving a street image;
detecting a face in the street image; and
performing a process on the detected face in the street image to protect personal privacy using a person detecting apparatus.

6. The method of claim 5, wherein the process includes mosaic process.

7. An image processing method comprising:
receiving a street image, the street image comprising at least one street, at least one face, and at least one building;
detecting a face in the street image, the face in the street image being located in front of the building; and
performing a process on the detected face in the front of the building in the street image to protect personal privacy using a person detecting apparatus.

8. The method of claim 7, wherein the process includes mosaic process.
